(19) United States
(12) Patent Application Publication
(10) Pub. No.: US 2013/0238564 A1
(43) Pub. Date: Sep. 12, 2013

(54) METHOD AND SYSTEM FOR SHARING REMOTE DATA

(71) Applicant: FILETREK INC., Ottawa (CA)

(72) Inventors: William Mark TUCKER, Ottawa (CA); Benjamin Freeman PIERCEY, Richmond (CA)

(73) Assignee: FILETREK INC., Ottawa (CA)

(21) Appl. No.: 13/781,968

(22) Filed: Mar. 1, 2013

Related U.S. Application Data
(60) Provisional application No. 61/607,301, filed on Mar. 6, 2012.

(51) Int. Cl. G06F 17/30

(52) U.S. Cl. CPC G06F 17/30115
USPC 707/656

(57) ABSTRACT

First and second local file systems remote one from another and having a hierarchical storage structure wherein files are stored within folders within the first local file system. A first file within the first local file system with an embedded link to a second file on the local system is mirrored with a third file within the second local file system. The second file is then mirrored to the second local file system and the third file comprises an embedded link to the mirrored second file on the second file system.

### FIELD OF THE INVENTION

The invention relates generally to communications, and more particularly to a method and system for sharing documents.

### BACKGROUND

Cloud based storage has been proposed and available for a long time. Initial attempts at cloud based storage allowed organizations to back up their data into the “cloud”—an offsite storage facility. In the event of a disaster or other data recovery need, the stored data was retrievable from the cloud for use.

With increases to data communication bandwidth, the use of cloud-based storage has increased. Services like DropBox® have gained popularity providing the ability to store data via the World Wide Web and share stored data. DropBox® provides each user with a storage space in the cloud. The user optionally creates a DropBox folder mirroring their DropBox®—cloud based storage—on their computer system. The DropBox® folder on their local system synchronises to their cloud based storage automatically such that the user is able to interact with local storage in order to backup or share data.

Using DropBox®, when a user removes a file from their DropBox® folder, the file is removed from the folder for everyone sharing the file. Further, whenever someone with access to a file changes that file, the file within each DropBox® folder changes. Thus, each user can have access to a same file within the cloud that remains synchronized while working with a local copy of said file.

Unfortunately, when using DropBox® any hyperlinks embedded in source files stored in the DropBox® folder will break unless the destination file is stored in the DropBox® folder as well. Also when using DropBox® the DropBox® folder gets extremely crowded as when files are removed, everyone sharing those files loses access to those files. Thus, there is a tendency to not remove files. Further, unless all local storage is mirrored to the cloud, there is a tendency to maintain all files in duplicate so that file organization is maintained within the local store.

### SUMMARY OF EMBODIMENTS OF THE INVENTION

According to an embodiment of the invention there is provided a method comprising: storing a first file within a first data store, the first file comprising an embedded link to a second file, the second file being a separate file stored within the first data store for being one of incorporated into the first file and hyperlinked from within the first file when the first file is displayed; selecting the first file by a first user and initiating by the first user mirroring of the first file to a third file, the third file stored within a second data store, the second data store in communication with the first data store via a communication network, the mirroring comprising transmitting first file data from the first data store to the second data store via the communication network; other than selecting the second file by the first user and other than initiating by the first user mirroring of the second file in the second data store; and when the third file is accessed, providing access to at least one of the second file and a mirror of the second file.

According to an embodiment of the invention there is provided a method comprising: storing a first file within a first data store, the first file comprising an embedded link to a second file, the second file being a separate file stored within the first data store and for being one of incorporated into the first file and hyperlinked from within the first file when the first file is displayed; selecting the first file by a first user and initiating by the first user mirroring of the first file to a third file, the third file stored within a second data store that is in communication with the first data store via a communication network, the mirroring comprising transmitting first file data from the first data store to the second data store via the communication network; absent selecting the second file by the first user, automatically mirroring the second data file on the second data store; and when the third file is accessed, providing access to at least one of the second file and a mirror of the second file.

According to an embodiment of the invention there is provided a method comprising: storing a first file within a first data store; storing a second file within the first data store; storing relationship data indicating a relationship between the first file and the second file; selecting the first file by a first user and initiating by the first user mirroring of the first file to a third file, the third file stored within a second data store, the second data store in communication with the first data store via a communication network, the mirroring comprising transmitting first file data from the first data store to the second data store via the communication network; other than selecting the second file by the first user and other than initiating by the first user mirroring of the second file in the second data store; and providing access to at least one of the second file and a mirror of the second file in relation to accessing the third file and absent mirroring of the second file.

According to an embodiment of the invention there is provided a method comprising: storing a first file within a first data store; storing a second file within the first data store; storing relationship data indicating a relationship between the first file and the second file; selecting the first file by a first user and initiating by the first user mirroring of the first file to a third file, the third file stored within a second data store, the second data store in communication with the first data store via a communication network, the mirroring comprising transmitting first file data from the first data store to the second data store via the communication network; selecting the second file by a first user and initiating by the first user mirroring of the second file to a fourth file, the fourth file stored within a second data store, the second data store in communication with the first data store via a communication network, the mirroring comprising transmitting second file data from the first data store to the second data store via the communication network; providing access to the fourth file in relation to accessing the third file, the fourth file stored in the second storage with a different absolute path to the fourth file location from the second file location and the relation between the third and fourth file other than stored within the first file as a relative file relation maintained in mirroring thereof.

### BRIEF DESCRIPTION OF THE DRAWINGS

FIG. 1 is a simplified block diagram showing two file systems, wherein the second file system comprises a file mirrored from a file within the first file system.

FIG. 2 is a simplified block diagram showing two file systems, wherein the second file system comprises a destination file mirrored from the first file system.

FIG. 3 is a simplified block diagram showing two file systems, wherein the second file system comprises a destination file mirrored from the first file system and stored in a hidden folder.

FIG. 4 is a simplified block diagram showing two file systems, wherein the first file system comprises a destination file mirrored from the second file system.

FIG. 5 is a simplified block diagram showing three data stores, wherein files are mirrored from the first data store to the second data store via cloud storage.

FIG. 6 is a simplified block diagram showing three data stores, wherein files are mirrored from the first data store to the second data store via cloud storage.

### DETAILED DESCRIPTION OF EMBODIMENTS OF THE INVENTION

### Definitions

Cloud Storage: File storage within a remote location accessed via a wide area network and managed and operated by a third party.

File System: The term file system refers to a system for file storage having a file organization architecture for organizing and locating files. Though the term file system is used, it is recognized that cloud based storage need not be in a single system nor need it be in a same storage at any given time or over a period of time.

Local File System refers to a system for file storage having a file organization architecture for organizing and locating files and that is local to a single system or network. Local file systems include file systems within local area network (LAN) servers, local hard drives, and removable media, for example. Local File Systems exclude cloud-based storage.

Mirrored is defined as copying a file to create one or more copies of the file, and when the file or one of the copies of the file are changed the file or one of the copies of the files are synchronised.

Synchronised: two or more files are considered to be synchronized when one of said two or more files is changed, the changes are then propagated to the other of said two or more files, often by copying the changed file, such that more than one file is synchronized most of the time.

Relative file location is defined as a file location relative to another file. Two files A and B have the same relative location as two other files C and D if and only if the minimum folders to encompass A and B have the same names and relations as the minimum folders to encompass C and D. For example, when A and B are each in separate folders HELLO and WORLD within a parent folder Q, then A and B have a same relative file structure to C and D when C and D are stored on a different storage medium in respective folders HELLO and WORLD within parent folder Q, even where parent folder Q is not within a same parent folder for each storage medium.

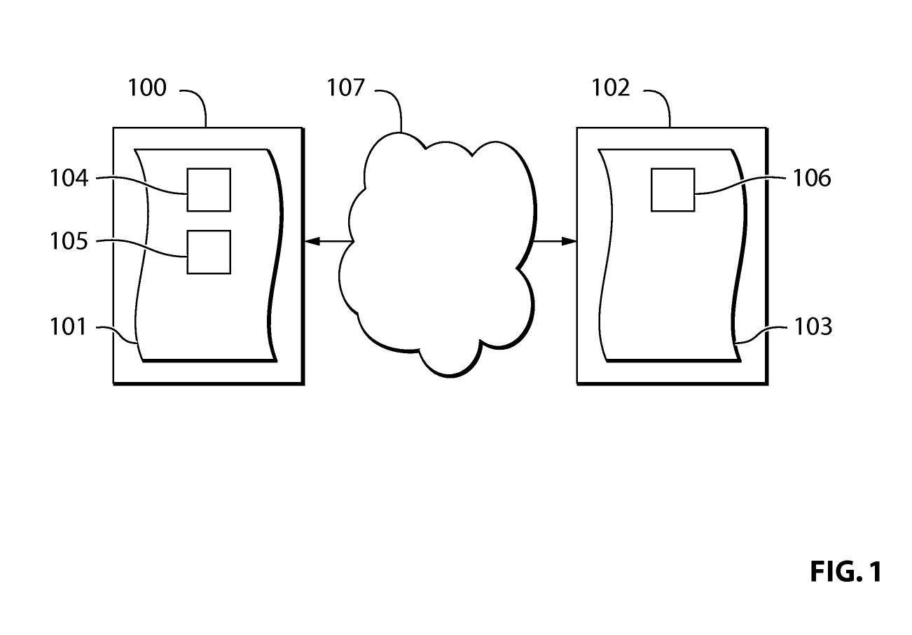

Referring to FIG. 1, shown is a simplified diagram of two file systems according to an embodiment of the invention. File system 101 is a first file system stored in a first data store, for example, file system 101 is stored in server 100. Server 100 is connected to a first intranet, not shown. File system 103 is a second file system stored in a second data store, for example, file system 103 is stored in server 102. Server 102 is remote from server 100 and is connected to a second intranet, also not shown. The two servers are in communication with one another via a communication network, in this case, server 100 and server 102 communicate via the Internet 107. Data on server 100 is accessible to local users only, for example, users connected to the first intranet. Otherwise security mechanisms, such as a firewall, prevent access to the data from outside the first intranet, for example from the Internet. Stored in file system 101 are files 104 and 105. File 104 is a user readable document, for example a Word® document, and comprises hypertext for opening a separate file when the hypertext is selected. For example, file 104 is a Word® document and a hyperlink to file 105 is embedded within the text of file 104. A hyperlink comprises a path to a destination file. For example, a hyperlink comprises the relative location to the destination file from the source file. In this example file 104 is the source file and file 105 is the destination file. Another example of a hyperlink is an absolute link comprising the full path to the destination file.

During use, a first user having access to the first intranet views file 104 and selects the hyperlink to file 105, thereby automatically opening file 105. Optionally, an object from file 105 is embedded into file 104. For example, an Excel® spread sheet is embedded into the Word® document such that when file 104 is viewed the Excel® spread sheet from file 105 appears in the Word® document.

Data on server 102 is accessible to local users only, for example, users connected to the second intranet. Otherwise security mechanisms, such as a firewall, prevent access to the data from outside the second intranet, for example from the Internet. The first user initiates mirroring of file 104 creating file 106 in the second file system 103 stored on server 102. For example, by selecting and right clicking on file 104 a menu is displayed providing an option to share file 104. The first user selects the share option to share file 104, and file 104 data is transmitted from server 100 to server 102 via the Internet. A second user connected to the second intranet opens file 106 and selects the hyperlink to file 105. In prior art the hyperlink would break as the destination file is no longer located in the path stored in the hyperlink. However, in this embodiment of the invention, the second user selects the hyperlink to file 105, and file 105 data is automatically transmitted from server 100 to server 102 via the Internet and opens for viewing. If the second user saves a copy of the transmitted file 105 on server 102, the hyperlink in file 106 will other than link to the copied file. That is to say, each time the hyperlink in file 106 is selected, file 105 data is automatically transmitted from server 100 to server 102, thereby ensuring that the second user accesses the latest version of file 105. Optionally, the first data store and the second data store are servers, PC's, cloud storage, or any combination thereof. Optionally the communication network is a WAN.

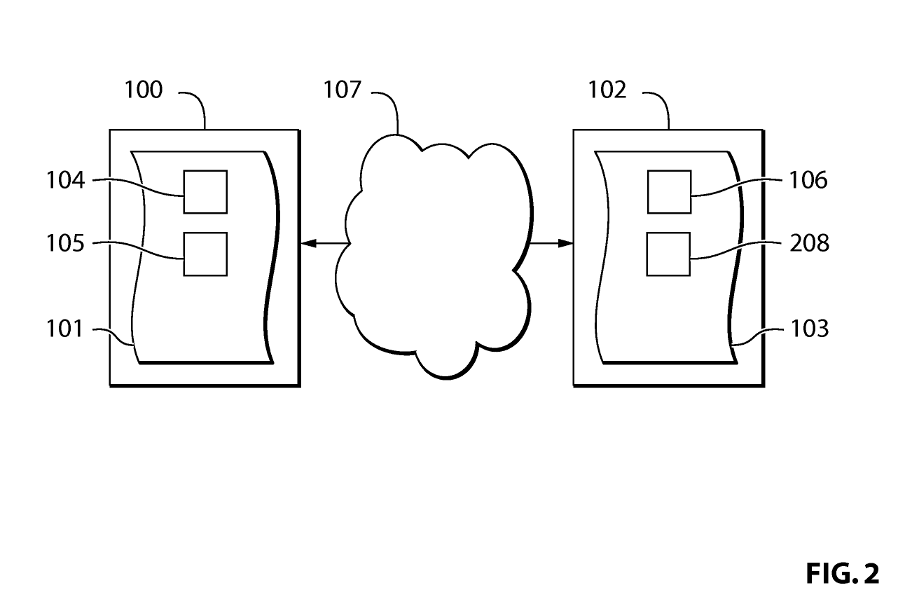

Referring to FIG. 2, shown is a simplified diagram of two file systems according to an embodiment of the invention. File system 101 is a first file system stored in a first data store, for example, file system 101 is stored in server 100. Server 100 is connected to a first intranet (not shown). File system 103 is a second file system stored in a second data store, for example, file system 103 is stored in server 102. Server 102 is remote from server 100 and is connected to a second intranet (also not shown). The two servers are in communication with one another via a communication network, in this case, server 100 and server 102 communicate via the Internet 107. Data on server 100 is accessible to local users only, for example, users connected to the first intranet. Otherwise security mechanisms, such as a firewall, prevent access to the data from outside the first intranet, for example from the Internet 107. Stored in file system 101 are files 104 and 105. File 104 is a user readable document, for example a Word® document, and comprises hypertext for opening a separate file when the hypertext is selected. For example, file 104 is a Word® document and a hyperlink to file 105 is embedded within the text of file 104. A hyperlink comprises a path to a destination file. For example, a hyperlink comprises the relative location to the destination file from the source file. In this example file 104 is the source file and file 105 is the destination file. Another example of a hyperlink is an absolute link comprising the full path to the destination file.

During use, a first user having access to the first intranet views file 104 and selects the hyperlink to file 105, thereby automatically opening file 105. Optionally, an object from file 105 is embedded into file 104. For example, an Excel® spread sheet is embedded into the Word® document such that when file 104 is viewed the Excel® spread sheet from file 105 appears in the Word® document.

Data on server 102 is accessible to local users only, for example, users connected to the second intranet. Otherwise security mechanisms, such as a firewall, prevent access to the data from outside the second intranet, for example from the Internet 107. The first user initiates mirroring of file 104 creating file 106 in the second file system 103 stored on server 102. For example, by selecting and right clicking on file 104 a menu is displayed providing an option to share file 104. The first user selects the share option to share file 104, and file 104 data is transmitted from server 100 to server 102 via the Internet 107. Once the sharing of a file is initiated, any document that is linked within the file is automatically shared. In this example, when sharing of file 104 is initiated the hyperlink to file 105 is detected in file 104 and file 105 data is automatically transmitted from server 100 to server 102 via the Internet 107 to create file 208. Further, the hyperlink in file 106 is modified such that when selected it links to file 208. A second user connected to the second intranet opens file 106, selects the hyperlink to file 208 and file 208 opens.

Accessing a local file is often more efficient than accessing a file remotely. Mirroring file 105 to server 102 ensures that the second user has efficient access to the most recent versions of files 104 and 105 as files 106 and 208 are automatically synchronised to files 104 and 105, respectively, when files 104 and 105 are modified. File 208 is a read-only file preventing the second user from modifying the file, ensuring that the second user does not unintentionally break the hyperlink. Alternatively, the second user modifies and saves file 208 on server 102. Optionally, the first data store and the second data store are servers, PC's, cloud storage, or any combination thereof. Optionally the communication network is a WAN.

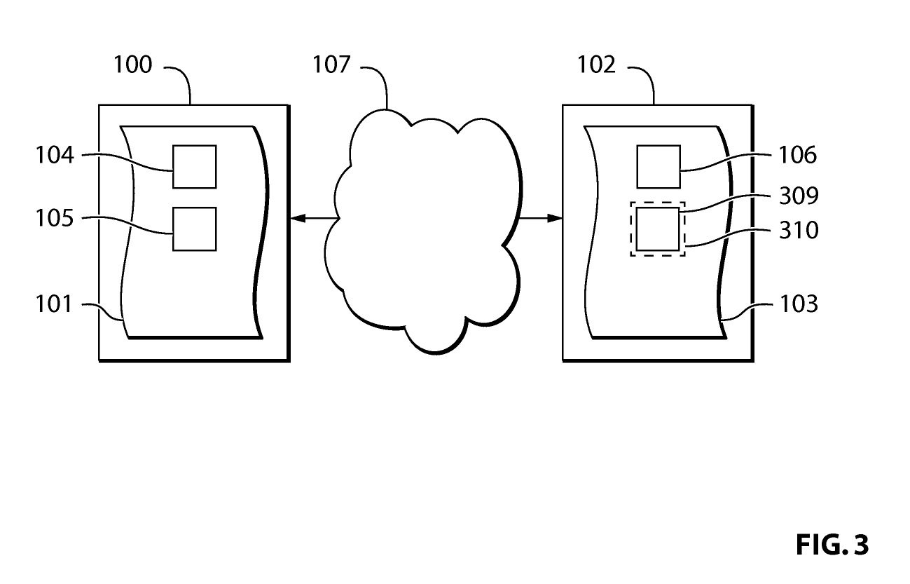

Referring to FIG. 3, shown is a simplified diagram of two file systems according to an embodiment of the invention. File system 101 is a first file system stored in a first data store, for example, file system 101 is stored in server 100. Server 100 is connected to a first intranet (not shown). File system 103 is a second file system stored in a second data store, for example, file system 103 is stored in server 102. Server 102 is remote from server 100 and is connected to a second intranet (also not shown). The two servers are in communication with one another via a communication network, in this case, server 101 and server 102 communicate via the Internet 107. Data on server 100 is accessible to local users only, for example, users connected to the first intranet. Otherwise security mechanisms, such as a firewall, prevent access to the data from outside the first intranet, for example from the Internet 107. Stored in file system 101 are files 104 and 105. File 104 is a user readable document, for example a Word® document, and comprises hypertext for opening a separate file when the hypertext is selected. For example, file 104 is a Word® document and a hyperlink to file 105 is embedded within the text of file 104. A hyperlink comprises a path to a destination file. For example, a hyperlink comprises the relative location to the destination file from the source file. In this example file 104 is the source file and file 105 is the destination file. Another example of a hyperlink is an absolute link comprising the full path to the destination file. A first user having access to the first intranet views file 104 and selects the hyperlink to file 105, automatically opening file 105. Optionally, an object from file 105 is embedded into file 104. For example, an Excel® spread sheet is embedded into the Word® document such that when file 104 is viewed the Excel® spread sheet from file 105 appears in the Word® document.

Data on server 102 is accessible to local users only, for example, users connected to the second intranet. Otherwise security mechanisms, such as a firewall, prevent access to the data from outside the second intranet, for example from the Internet 107. The first user initiates mirroring file 104 creating file 106 in the second file system 103 stored on server 102. For example, by selecting and right clicking on file 104 a menu is displayed providing an option to share file 104. The first user selects the share option to share file 104, and file 104 data is transmitted from server 100 to server 102 via the Internet 107. Once the sharing of a file is initiated, any document that is linked within the file is automatically shared. In this example, when sharing file 104 is initiated the hyperlink to file 105 is detected in file 104 and file 105 data is automatically transmitted from server 100 to server 102 via the Internet 107 to create file 309 which is stored in hidden folder 310, as indicated with dashed lines. Further, the hyperlink in file 106 is modified such that the hyperlink, when selected, links to file 309. A second user connected to the second intranet opens file 106, selects the hyperlink to file 309 and file 309 opens. The second user is unaware of file 309 as it is located in hidden folder 310. Accessing a local file is often more efficient than accessing a file remotely. Mirroring file 105 to server 102 ensures that the second user has efficient access to the most recent versions of files 104 and 105 as files 106 and 309 are automatically synchronised to the files 104 and 105, respectively, when files 104 and 105 are modified. Storing file 309 in hidden folder 310 protects file 309 from modification by the second user. Optionally, the first data store and the second data store are servers, PC's, cloud storage, or any combination thereof. Optionally the communication network is a WAN.

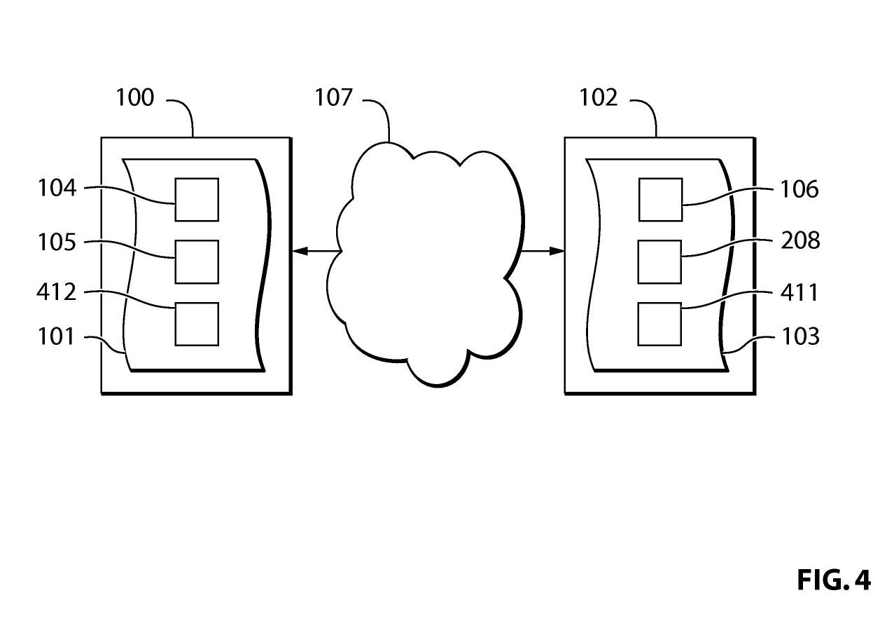

Referring to FIG. 4, shown is a simplified diagram of two file systems according to an embodiment of the invention. File system 101 is a first file system stored in a first data store, for example, file system 101 is stored in server 100. Server 100 is connected to a first intranet (not shown). File system 103 is a second file system stored in a second data store, for example, file system 103 is stored in server 102. Server 102 is remote from server 100 and is connected to a second intranet (also not shown). The two servers are in communication with one another via a communication network, in this case, server 101 and server 102 communicate via the Internet 107. Data on server 100 is accessible to local users only, for example, users connected to the first intranet. Otherwise security mechanisms, such as a firewall, prevent access to the data from outside the first intranet, for example from the Internet 107. Stored in file system 101 are files 104 and 105. File 104 is a user readable document, for example a Word® document, and comprises hypertext for opening a separate file when the hypertext is selected. For example, file 104 is a Word® document and a hyperlink to file 105 is embedded within the text of file 104. A hyperlink comprises a path to a destination file. For example, a hyperlink comprises the relative location to the destination file from the source file. In this example file 104 is the source file and file 105 is the destination file. Another example of a hyperlink is an absolute link comprising the full path to the destination file. A first user having access to the first intranet views file 104 and selects the hyperlink to file 105, automatically opening file 105. Optionally, an object from file 105 is embedded into file 104. For example, an Excel® spread sheet is embedded into the Word® document such that when file 104 is viewed the Excel® spread sheet from file 105 appears in the Word® document.

Data on server 102 is accessible to local users only, for example, users connected to the second intranet. Otherwise security mechanisms, such as a firewall, prevent access to the data from outside the second intranet, for example from the Internet 107. The first user initiates mirroring of file 104 creating file 106 in the second file system 103 stored on server 102. For example, by selecting and right clicking on file 104 a menu is displayed providing an option to share file 104. The first user selects the share option to share file 104, and file 104 data is transmitted from server 100 to server 102 via the Internet 107. Once the sharing of a file is initiated, any document that is linked within the file is automatically shared. In this example, when sharing file 104 is initiated the hyperlink to file 105 is detected in file 104 and file 105 data is automatically transmitted from server 100 to server 102 via the Internet 107 to create file 208. Further, the hyperlink in file 106 is modified such that when selected it links to file 208. A second user connected to the second intranet opens file 106, selects the hyperlink to file 208, and file 208 opens.

The second user having file permission to modify file 106, embeds a second hyperlink to file 411 stored in file system 103 on server 102. File 104 is automatically synchronised with file 106 by transmitting file 106 data from server 102 to server 100 via the Internet 107. Further, the destination file 411 is mirrored to server 100 by transmitting file 411 file data from server 102 to server 100 to create file 412. Also, the second hyperlink in file 104 is modified such that when selected it links to file 412. The first user connected to the first intranet opens file 104, selects the second hyperlink to file 412, and file 412 opens. Sharing source files and associated destination files with multiple data stores provides efficient access to the source files and associated destination files at each one of the multiple of data stores. Optionally, an object from file 411 is embedded into file 106. For example, an Excel® spread sheet is embedded into the Word® document such that when file 106 is viewed the Excel® spread sheet from file 412 appears in the Word® document. Optionally, the first data store and the second data store are servers, PC's, cloud storage, or any combination thereof. Optionally the communication network is a WAN.

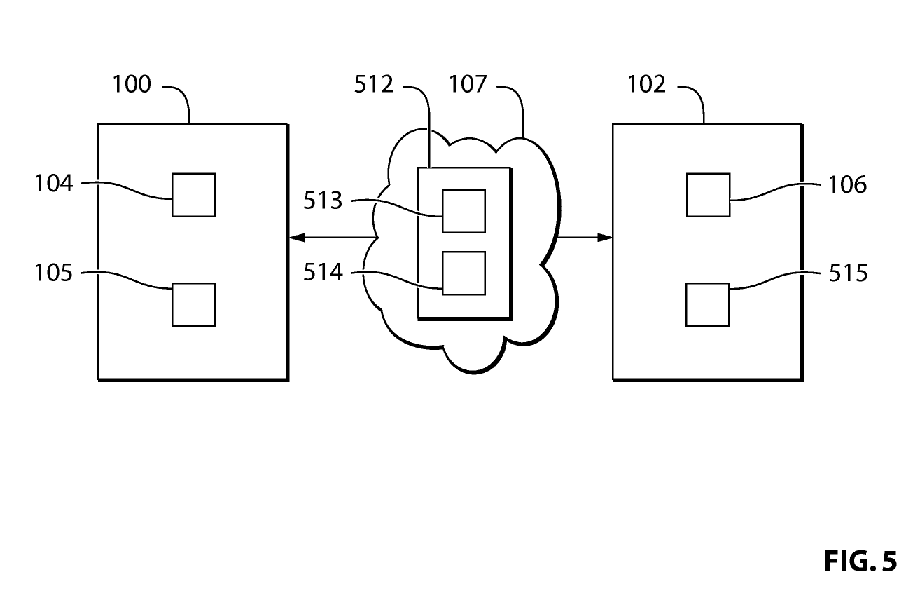

Referring to FIG. 5 shown is a simplified diagram of three data stores according to an embodiment of the invention. Data store 100 is located locally and is connected to a first intranet (not shown), cloud storage 512 is located within the cloud, and data store 102 is stored at a remote location and is connected to a second intranet (also not shown). Cloud storage 512 is in communication with data store 100 and data store 102 via a communication network, for example, the Internet 107. Data on data store 100 is accessible to local users only, for example users on the first intranet, otherwise security mechanisms, such as a firewall, prevent access to data store 100 by those not connected to the first intranet. Stored in data store 100 are files 104 and 105. The file 104 is a user readable document and comprises embedded hypertext for linking to file 105, for example, file 104 is a Word® document and a hyperlink to file 105 is embedded in the text. A hyperlink comprises the path to a destination file. For example, a hyperlink comprises the relative location to the destination file from the source file. Another example of a hyperlink is an absolute link comprising the full path to the destination file. In this example file 104 is the source file and file 105 is the destination file. When a first user views file 104 and selects the hyperlink to file 105, file 105 automatically opens. Optionally, an object from file 105 is embedded into file 104. For example, an Excel® spread sheet is embedded into the Word® document such that when file 104 is viewed the Excel® spread sheet from file 105 appears in the Word® document.

Data on data store 102 is accessible to local users only, for example users on a second intranet, otherwise security mechanisms, such as a firewall, prevent access to data store 102 by those not connected to the second intranet. The first user initiates mirroring of file 104 to data store 102. For instance, the first user selects and right clicks on file 104 and a menu is displayed providing an option to share file 104. The first user selects the share option to share file 104, and file 104 file data is transmitted from data store 100 to cloud storage 512 via the Internet 107 to form file 513. Once the sharing of a file is initiated, any document that is linked within a mirrored file is automatically shared. In this example, upon initiating sharing of file 104 the hyperlink to file 105 is detected in file 104 and file 105 data is automatically transmitted from data store 100 to cloud storage 512 via the Internet 107, creating file 514 which is also stored in cloud storage 512. Also, the hyperlink in file 513 is modified such that the hyperlink, when selected, links to file 514. Files 513 and 514 are then mirrored to data store 102 by transmitting file 513 file data and file 514 file data from cloud storage 512 to data store 102 to form files 106 and 515, respectively, and the hyperlink in file 106 is modified such that the hyperlink, when selected, links to file 515.

A second user connected to the second intranet opens file 106, selects the hyperlink to file 515, and file 515 opens. The second user is unaware of the presence of mirrored files 513 and 514 stored in cloud storage 512. Mirroring files 104 and 105 to cloud storage 512 reduces the data traffic on the first intranet when the files are mirrored to multiple data stores. For example, mirroring files 104 and 105 to a not illustrated third local data store comprises transmitting file 513 file data and file 514 file data from cloud storage 512 to the third local data store instead of transmitting file 104 data and file 105 data to the third local data store. In this example files 104 and 105 do not need to be accessed when they are mirrored a second time. Optionally, the first data store 100 and the second data store 102 are servers, PC's, cloud storage, or any combination thereof. Optionally the communication network is a WAN.

Though the embodiments above are all described with reference to a hyperlink within a document, externally indicated links are also supported. For example, file tracking is performed by a change management system or by the file system itself to track when a file is modified or saved under a different name. This allows users to revert to older versions of files or to see changes made—differences—between different versions of files. As such, though the relation between the files is stored external to the files themselves, they are accessible on the first system and are optionally provided to the second other system for mirroring of related files. This is particularly useful when files are closely related and not hyperlinked—references relied upon in a document or calculation worksheets for example. This is also useful for group work wherein changes to documents sometimes are referred to in order to get a better understanding of the parties' motivations. Of course, there are many applications for tracking file relations and mirroring of related files. In some applications, preferences provide control over mirroring; in others, mirroring is based on file access; in yet others, mirroring is automated. Of course, a single process for file mirroring of related files is also possible regardless of the application.

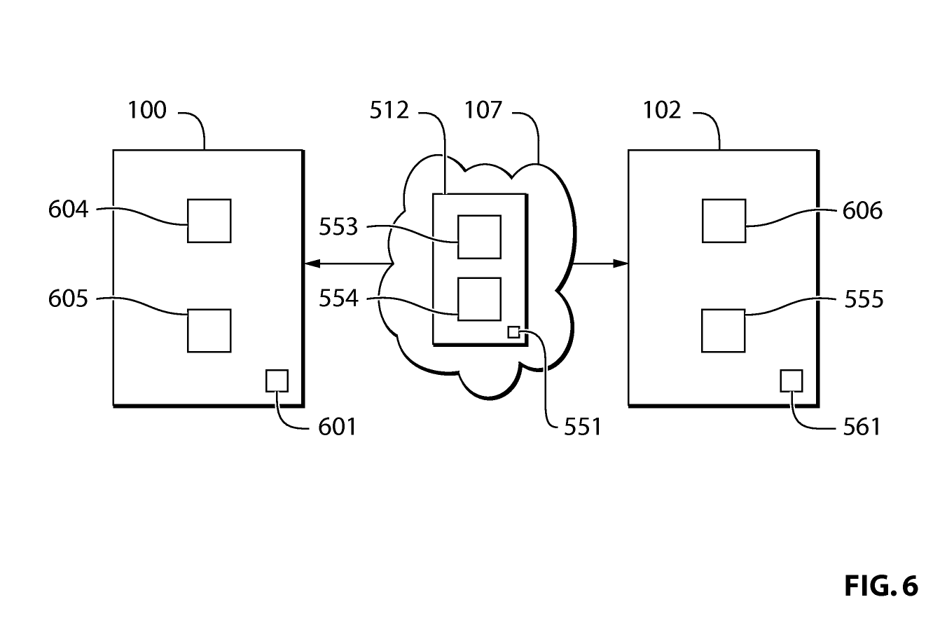

Referring to FIG. 6 shown is a simplified diagram of three data stores according to an embodiment. Data store 100 is located locally and is connected to a first intranet (not shown), cloud storage 512 is located within the cloud, and data store 102 is stored at a remote location and is connected to a second intranet (also not shown). Cloud storage 512 is in communication with data store 100 and data store 102 via a communication network, for example, the Internet 107. Data on data store 100 is accessible to local users only, for example users on the first intranet, otherwise security mechanisms, such as a firewall, prevent access to data store 100 by those not connected to the first intranet. Stored in data store 100 are files 604 and 605. Further file 601 is stored in data store 100 and indicates relationships between files stored thereon. For example, files opened automatically with other files are indicated as such. Further, files that are exports of data from other files have that relationship noted. Of course, other or different relationships are optionally recorded. The file 604 is a user readable document and relates to file 605, for example, file 604 is a Word® document formed by modifying file 605 and storing the result under a new filename.

Data on data store 102 is accessible to local users only, for example users on a second intranet, otherwise security mechanisms, such as a firewall, prevent access to data store 102 by those not connected to the second intranet. The first user initiates mirroring of file 604 to data store 102. For instance, the first user selects and right clicks on file 604 and a menu is displayed providing an option to share file 604. The first user selects the share option to share file 604, and file 604 file data is transmitted from data store 100 to cloud storage 512 via the Internet 107 to form file 553. Once the sharing of a file is initiated, data relating to related files to file 604 is also transmitted to the cloud storage 512. Access to the related file, 605, is provided via one of the many methods described above or another method. For example, any document relating to mirrored file 553 is automatically mirrored. Alternatively, related files are shared when requested. Further alternatively, all related files are mirrored to cloud storage but are then only mirrored to other systems when accessed. In this example, upon initiating sharing of file 604 the file 605 is identified and mirrored as well—is automatically transmitted from data store 100 to cloud storage 512 via the Internet 107, creating file 554 which is also stored in cloud storage 512. Data within file 551 is updated indicating any relations between the file 604 and other files such as 554, which is mirrored from file 605. Files 553 and 554 are then mirrored to data store 102 by transmitting file 553 file data and file 554 file data from cloud storage 512 to data store 102 to form files 606 and 555, respectively. File 561 is updated indicating a relationship between the newly mirrored files.

Because data from file 601 is provided for updating files 551 and 561, the files 551 and 561 are updatable when the files they refer to are moved or changed. Thus, some form of synchronization is maintained, preferably without mirroring the files indicative of the relationships between files. Thus, when two files are stored in a same folder on one system but in different folders on another system, the relationship can be tracked, maintained, and modified as occurs.

A second user connected to the second intranet opens file 606, selects the hyperlink to file 555, and file 555 opens. In this example files 604 and 605 do not need to be accessed when they are mirrored a second time. Optionally, the first data store 100 and the second data store 102 are servers, PC's, cloud storage, or any combination thereof. Optionally the communication network is a WAN.

Because the relationship between files is stored external thereto, the present embodiment also allows for trapping of hyperlink references and other references in order to maintain file names within mirrored directories without modifying mirrored files and without forcing mirrored file path names to be consistent.

Numerous embodiments of the invention will be apparent to one of skill in the art without departing from the scope of the invention.

What is claimed is:

1. A method comprising:
storing a first file within a first data store, the first file comprising an embedded link to a second file, the second file being a separate file stored within the first data store for being one of incorporated into the first file and hyperlinked from within the first file when the first file is displayed;
selecting the first file by a first user and initiating by the first user mirroring of the first file to a third file, the third file stored within a second data store, the second data store in communication with the first data store via a communication network, the mirroring comprising transmitting first file data from the first data store to the second data store via the communication network;
other than selecting the second file by the first user and other than initiating by the first user mirroring of the second file in the second data store; and
when the third file is accessed, providing access to at least one of the second file and a mirror of the second file.

2. The method according to claim 1 comprising:
detecting the second file as being one of incorporated in the first file and hyperlinked from within the first file when displayed;
automatically mirroring the second file in the second data store, the mirroring of the second file comprising transmitting second file data from the first data store to the second data store via the communication network; and
when the third file is accessed, providing access to the mirror of the second file stored within the second data store.

3. The method according to claim 2 comprising mirroring the second file in a hidden folder stored in the second data store.

4. The method according to claim 2 comprising:
modifying the mirror of the second file by synchronizing the mirror of the second file with the second file, wherein synchronizing comprises transmitting second file data from the first data store to the second data store via the communication network; and
other than modifying the mirror of the second file by a second user.

5. The method according to claim 4 wherein synchronizing comprises synchronizing via a cloud storage.

6. The method according to claim 1 wherein the second data store is located remotely from the first data store.

7. The method according to claim 6 wherein the second data store is located in cloud storage.

8. The method according to claim 1 comprising:
storing a fourth file in the second data store;
embedding into the third file a link to the fourth file, the fourth file being a separate file for being one of incorporated into the third file and hyperlinked from within the third file when the third file is displayed;
synchronizing the first file with the third file by transmitting third file data from the second data store to the first data store via the communication network; and
upon accessing the first file, providing access to at least one of the fourth file and a mirror of the fourth file.

9. The method according to claim 8 comprising:
mirroring the third file to a fifth file stored in cloud storage, by transmitting third file data from the second data store to the cloud storage via the communication network;
mirroring the fourth file to sixth file, by transmitting fourth file data from the second data store to the cloud storage via the communication network;
synchronizing the first file with the third file by transmitting third file data from the cloud storage to the first data store via the communication network and by transmitting fourth file data from the cloud storage to the first data store via the communication network; and
when the first file is accessed, providing access to at least one of the fourth file and a mirror of the fourth file.

10. The method according to claim 9 wherein synchronizing the first file with the third file comprises embedding a link to the mirror of the fourth file into the first file, the mirror of the fourth file being one of incorporated into the first file and hyperlinked from within the first file when the first file is displayed.

11. The method according to claim 1 comprising mirroring via a cloud storage.

12. A method according to claim 1 wherein mirroring of the second file comprises embedding a link to the mirror of the second file into the third file, for being one of incorporated into the third file and hyperlinked from within the third file when the third file is displayed.

13. The method according claim 1 wherein the embedded link to the second file in the first file is a relative link in a first local file system in the first data store, the embedded link to the second file comprising a relative file location path of the second file to the first file;
wherein mirroring the second file in the second data store comprises storing the fourth file in the same relative file location to the third file as the relative file location of the second file to the first file, the fourth file and the third file in a second local file system in the second data store; and
modifying the embedded link to the fourth file in the third file, wherein the embedded link to the fourth file comprises the relative location path of the fourth file to the third file.

14. The method according to claim 1 wherein the embedded link to the second file in the first file is an absolute link in a first local file system in the first data store, the embedded link to the second file comprising the full location path of the second file; and
wherein mirroring the second file in the second data store comprises modifying the embedded link to the fourth file in the third file, wherein the embedded link to the fourth file comprises a location path of the fourth file to the third file.

15. A method comprising:
storing a first file within a first data store, the first file comprising an embedded link to a second file, the second file being a separate file stored within the first data store and for being one of incorporated into the first file and hyperlinked from within the first file when the first file is displayed;
selecting the first file by a first user and initiating by the first user mirroring of the first file to a third file, the third file stored within a second data store that is in communication with the first data store via a communication network, the mirroring comprising transmitting first file data from the first data store to the second data store via the communication network;
absent selecting the second file by the first user, automatically mirroring the second data file on the second data store; and
when the third file is accessed, providing access to at least one of the second file and a mirror of the second file.

16. The method according to claim 15, wherein automatically mirroring the second data file comprises detecting the second file as being one of incorporated in the first file and hyperlinked from within the first file.

17. A method comprising:
storing a first file within a first data store, the first file comprising an embedded link to a second file, the second file being a separate file stored within the first data store and for being one of incorporated into the first file and hyperlinked from within the first file when the first file is displayed;
selecting the first file by a first user and initiating by the first user mirroring of the first file to a third file, the third file stored within a second data store that is in communication with the first data store via a communication network, the mirroring comprising transmitting first file data from the first data store to the second data store via the communication network; and
when the third file is accessed, providing access to the second file stored on the first data store.

18. A method comprising:
storing a first file within a first data store;
storing a second file within the first data store;
storing relationship data indicating a relationship between the first file and the second file;
selecting the first file by a first user and initiating by the first user mirroring of the first file to a third file, the third file stored within a second data store, the second data store in communication with the first data store via a communication network, the mirroring comprising transmitting first file data from the first data store to the second data store via the communication network;
other than selecting the second file by the first user and other than initiating by the first user mirroring of the second file in the second data store; and
providing access to at least one of the second file and a mirror of the second file in relation to accessing the third file and absent mirroring of the second file.

19. A method comprising:
storing a first file within a first data store;
storing a second file within the first data store;
storing relationship data indicating a relationship between the first file and the second file;
selecting the first file by a first user and initiating by the first user mirroring of the first file to a third file, the third file stored within a second data store, the second data store in communication with the first data store via a communication network, the mirroring comprising transmitting first file data from the first data store to the second data store via the communication network;
selecting the second file by a first user and initiating by the first user mirroring of the second file to a fourth file, the fourth file stored within a second data store, the second data store in communication with the first data store via a communication network, the mirroring comprising transmitting second file data from the first data store to the second data store via the communication network;
providing access to the fourth file in relation to accessing the third file, the fourth file stored in the second storage with a different absolute path to the fourth file location from the second file location and the relation between the third and fourth file other than stored within the first file as a relative file relation maintained in mirroring thereof.
